(19) United States
(12) Patent Application Publication
(10) Pub. No.: US 2024/0145885 A1
(43) Pub. Date: May 2, 2024

(54) WIRE BOND FUSE DOWN-SELECT FOR ELECTROCHEMICAL CELLS

(71) Applicant: EAGLEPICHER TECHNOLOGIES, LLC, Joplin, MO (US)

(72) Inventors: Kyle James HILL, Joplin, MO (US); Kevin Andrew NOLTE, Joplin, MO (US); Juan M. MARTINEZ VALENCIA, Joplin, MO (US); Jason KRENTZ, Joplin, MO (US); John Kenneth GEORGE, Joplin, MO (US)

(21) Appl. No.: 18/547,095

(22) PCT Filed: Feb. 15, 2022
(86) PCT No.: PCT/US2022/016391

§ 371 Date: Aug. 18, 2023

Related U.S. Application Data
(60) Provisional application No. 63/150,801, filed on Feb. 18, 2021.

(51) Int. Cl. H01M 50/583; H01M 50/213; H01M 50/51; H01M 50/512; H01M 50/514

(52) U.S. Cl. CPC H01M 50/583; H01M 50/213; H01M 50/51; H01M 50/512; H01M 50/514; H01M 2200/103

(57) ABSTRACT

Cell assemblies and methods for assembling cell assemblies include installing a plurality of cells within a cell housing and electrically connecting each cell to each other cell through at least one wire bond, wherein each wire bond is selected to conduct current from a respective cell during normal operation and to sever such electrical connection through the wire bond when a predetermined current exceeds a threshold value for a predetermined period of time.

### CROSS REFERENCE TO RELATED APPLICATIONS

This application claims priority to and the benefit of U.S. Application No. 63/150,801, filed on Feb. 18, 2021, which is incorporated herein by reference in its entirety.

### BACKGROUND

Lithium Ion electrochemical cells are used as power sources in various devices and applications. Often, such cells are utilized as battery packs for supplying power to, for example, electric vehicles, land vehicles, aircraft, and/or marine vessels. As Lithium Ion and other types of electrochemical cells can be volatile, fusing features are often used to prevent unsafe operation. It would be desirable to provide improved designs that can act, not only as a current carrying device between two media, but also as a precise fusing element that can endure various implementations, applications, environments, or the like.

### SUMMARY

According to some embodiments, methods for assembling cell assemblies are provided. The methods include installing a plurality of cells within a cell housing and electrically connecting each cell to each other cell through at least one wire bond, wherein each wire bond is selected to conduct current from a respective cell during normal operation and to sever such electrical connection through the wire bond when a predetermined current exceeds a threshold value for a predetermined period of time.

In addition to one or more of the features described herein, or as an alternative, further embodiments of the method may include that the cells are electrically connected in series.

In addition to one or more of the features described herein, or as an alternative, further embodiments of the method may include that a wire bond of one cell connects from a positive terminal of the cell to a negative terminal of an adjacent cell.

In addition to one or more of the features described herein, or as an alternative, further embodiments of the method may include that the cells are electrically connected in parallel.

In addition to one or more of the features described herein, or as an alternative, further embodiments of the method may include that each wire bond is connected to a conductor that electrically connects the plurality of cells.

In addition to one or more of the features described herein, or as an alternative, further embodiments of the method may include selecting at least one of a wire length, a wire diameter, a wire coating, and a wire material of the wire bond such that the wire bond will sever based on the threshold value and predetermined period of time.

In addition to one or more of the features described herein, or as an alternative, further embodiments of the method may include that the selection of the wire bond is determined to fall within a wire bond region of an Ft plot that is defined between a minimum time-current curve and a maximum time-current curve and wherein the severing of the wire bond occurs at one or more predetermined currents and durations of such predetermined currents.

According to some embodiments, cell assemblies are provided. The cell assemblies include a plurality of cells arranged within a housing and at least one wire bond electrically connected from each cell of the plurality of cells to the other cells of the plurality of cells, wherein each wire bond is selected to conduct current from a respective cell during normal operation and to sever such electrical connection through the wire bond when a predetermined current exceeds a threshold value for a predetermined period of time.

In addition to one or more of the features described herein, or as an alternative, further embodiments of the cell assemblies may include that the cells are electrically connected in series.

In addition to one or more of the features described herein, or as an alternative, further embodiments of the cell assemblies may include that a wire bond of one cell connects from a positive terminal of the cell to a negative terminal of an adjacent cell.

In addition to one or more of the features described herein, or as an alternative, further embodiments of the cell assemblies may include that the cells are electrically connected in parallel.

In addition to one or more of the features described herein, or as an alternative, further embodiments of the cell assemblies may include a conductor, wherein each wire bond is connected to the conductor that electrically connects the plurality of cells.

In addition to one or more of the features described herein, or as an alternative, further embodiments of the cell assemblies may include an adhesive layer arranged between the conductor and the housing and configured to secure the conductor to the housing.

In addition to one or more of the features described herein, or as an alternative, further embodiments of the cell assemblies may include a stiffening layer arranged between the conductor and the housing and configured to provide stability to the conductor.

In addition to one or more of the features described herein, or as an alternative, further embodiments of the cell assemblies may include a cell assembly positive terminal and a cell assembly negative terminal configured to electrically connect to an external electrical device.

In addition to one or more of the features described herein, or as an alternative, further embodiments of the cell assemblies may include that the at least one wire bond of each cell is connected at a positive terminal of the respective cell, the cell assembly further comprising at least one additional wire bond configured to attach to a negative terminal of the respective cells.

### BRIEF DESCRIPTION OF THE DRAWINGS

FIG. 1A depicts aspects of an electrochemical cell assembly including a plurality of individual electrochemical cells and a plurality of wire bond fusing elements arranged in parallel in accordance with an embodiment of the present disclosure;

FIG. 1B is an enlarged view of a portion of the cell assembly of FIG. 1A;

FIG. 1C is a bottom view perspective of the cell assembly of FIG. 1A;

FIG. 2A depicts an electrochemical cell assembly connected in series with bonding to the tops of the cells in accordance with an embodiment of the present disclosure;

FIG. 2B is a bottom perspective view of the electrochemical cell assembly of FIG. 2A;

FIG. 3 is an example plot illustrating how to down-select the fusing characteristics of a wire bond in accordance with embodiments of the present disclosure; and

FIG. 4 illustrates a cell assembly in accordance with an embodiment of the present disclosure having dual-wire wire bonds with cells connected in parallel.

### DETAILED DESCRIPTION

Inventive aspects of the disclosure are explained in detail below with reference to the various drawing figures. Examples are described to illustrate the disclosed subject matter, not to limit its scope. Those of ordinary skill in the art will recognize a number of equivalent variations of the various features provided in the description that follows.

The present disclosure relates to electrochemical cells, such as Lithium Ion electrochemical cells, and to fusing devices or fusing elements for use in electrochemical cell assemblies. It is noted that the disclosed cell assemblies and components thereof are not so limited, as aspects may be used with a variety of types of electrochemical cells, such as Nickel metal hydride cells, Nickel cadmium cells, Silver zinc cells, various Lithium-based cells, any cylindrical electrochemical cells, and the like as will be appreciated by those of skill in the art.

An aspect of an electrochemical cell assembly includes a plurality of individual electrochemical cells, such as Lithium Ion cells. The cell assembly (e.g., a battery pack) includes a plurality of fusing elements. Each cell is electrically connected to other cells by a respective fusing element. Each fusing element includes or is configured as a wire having a first end that is bonded to a cell terminal, and a second end that is bonded to either a conductor or to another cell terminal so as to electrically connect the cells in either a series or parallel configuration. Such a wire, as bonded or attached, is referred to as a “wire bond.” Each wire bond is systematically designed by selecting attributes of the respective wire, such as wire type and material, diameter, length, shape, resistance, coating, and others. The attributes can be selected for the appropriate fusing characteristics desired for any given application.

The fuses or fusing elements described herein are electrically conductive elements (e.g., wires) that are selected and configured to break or cease conducting electricity upon reaching certain conditions. For example, the wires described herein may be selected to melt or otherwise break and sever an electrical connection due to high temperature and/or excessive current passing through such fuses. The purpose of such fuses is to ensure that a single cell of a cell assembly does not cause a cascade event due to a short circuit or the like and/or to prevent thermal runaway. The fuse elements will sever the electrical connection of a single failed cell and thus prevent further cell failures by electrically isolating the cell from the rest of the cells of a cell assembly.

Aspects of electrochemical cells and cell assemblies described herein present a number of advantages and address a number of problems. For example, Lithium Ion cells can be volatile and therefore unsafe if not monitored correctly. Protecting these cells with fusing is one way to ensure safe operation. Conventional fuses have limitations that some implementations may not be able to endure. Wire bond fusing elements as described herein and in accordance with embodiments of the present disclosure have a wider applicability and can endure conditions that may not be suitable for conventional fuses.

The fusing elements described herein are systematically designed or tuned to open when designed. Such fusing elements can eliminate the need for conventional fuses, while also providing a current carrying path between two previously difficult to connect media. Furthermore, the use of wire bond fusing elements can reduce or eliminate the threat of an individual cell short-circuit from destroying the whole cell assembly or entire battery bank, while allowing operation of the remaining cells of an assembly to continue.

Wire bond fusing elements as described herein are advantageous, for example, because they take up significantly less space than other fusing configurations, such as conventional fusible links and weld tabs. In addition, wire bonds are able to withstand higher voltages after being open than conventional fuses and promote safer operation after opening than conventional fuses. For example, a wire bond that is open exhibits a large air gap between the residual wires, which allows the wire bond to operate safely in systems with higher voltage than conventional fuses. Wire bonds are also less rigid and lighter weight than other fusing configurations, making them capable of withstanding higher vibration profiles.

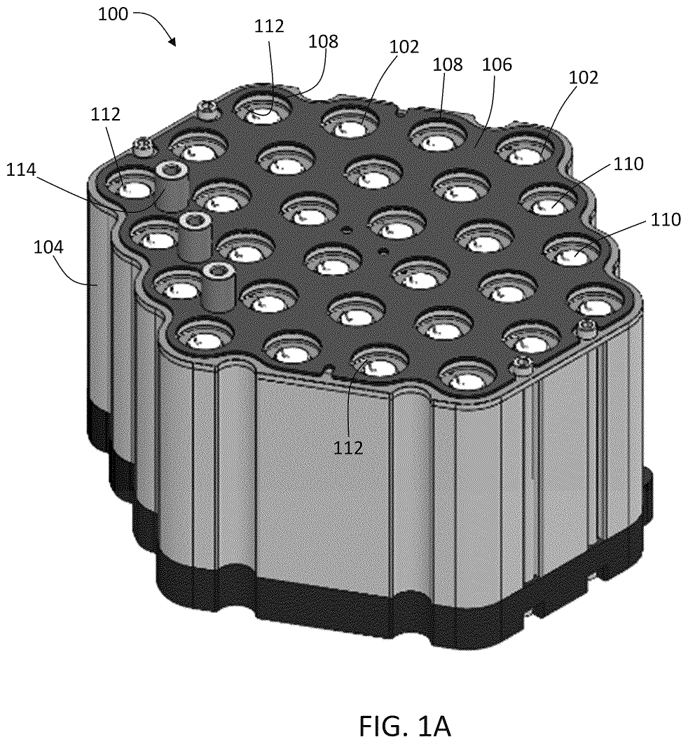

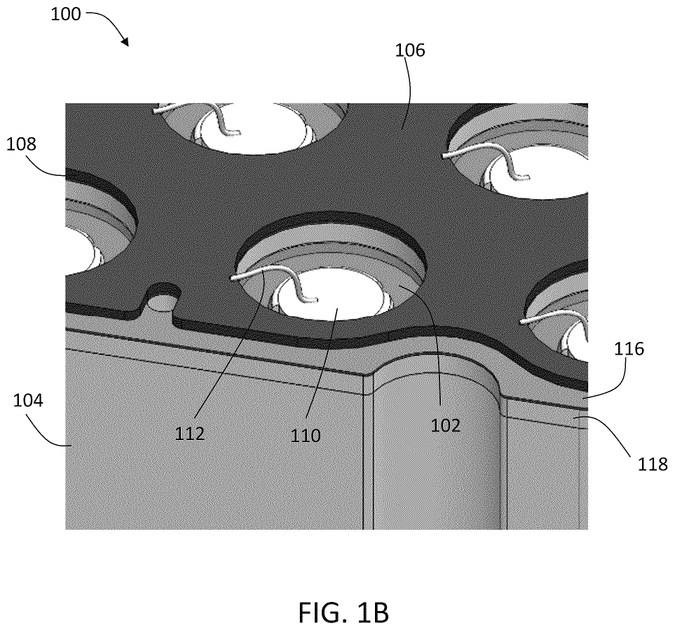

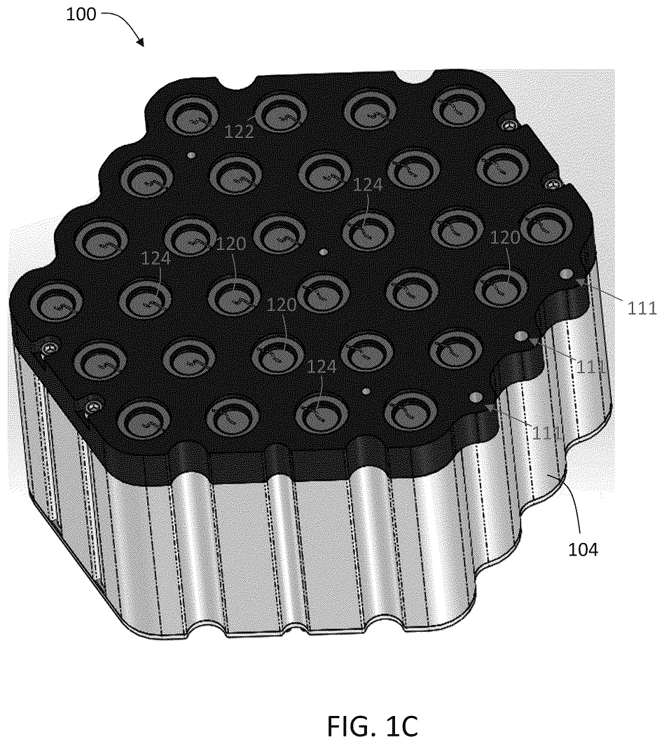

FIGS. 1A-1C depict aspects of an electrochemical cell assembly 100 in accordance with an embodiment of the present disclosure. The cell assembly 100 has a number of individual electrochemical cells 102, which are electrically connected in parallel to achieve a desired capacity. Multiple cell assemblies 100 may be connected in series as a string to achieve additional voltage. In an aspect, the electrochemical cells 102 are Lithium-ion cells, but may be any other suitable type of cell.

The cell assembly 100 includes a housing 104 configured to retain and insulate the cells 102. A conductor 106 is disposed in or on the housing 104 and is configured to electrically connect the cells 102 in parallel. The housing 104 may be formed from a non-conducting material and is configured to secure the cells 102 in the cell assembly 100. The conductor 106 is a sheet of a conductive material (e.g., copper) that includes a plurality of holes 108. Each hole 108 is positioned proximate to a positive terminal 110 of a cell 102. The assembly 100 includes an additional conductor electrically connected to negative terminals of the cells 102 to form a cell assembly negative terminal 111 (see, e.g., FIG. 1C). In this illustrative embodiment, the conductor 106 forms a top or cover to the housing 104. However, in other embodiments, the conductor may be positioned or arranged in an alternative fashion. For example, the housing may include an insulative top and the conductor may be arranged beneath such insulative top, while still electrically connecting the various cells of the cell assembly.

Each cell 102 is electrically connected to the conductor 106 by a fusing element or wire bond 112. The wire bonds 112 are not only used to carry current from one medium to another, but are also designed to have desired fusing characteristics, such as, to hold a desired amount of current and open (or break) under a desired current threshold to avoid excessive current. For example, the wire bonds 112 are configured to carry current from each individual cell 102 into the conductor 106 and then through a cell assembly positive terminal 114 to an external electrical component. In addition to providing such electrical connection, the wire bonds 112 are configured to sever such connection between the individual cells 102 and the conductor 106 when certain operational conditions exist (e.g., short circuit, thermal runaway, volatile events, etc.). The wire bonds 112 may be formed from suitable materials, including, for example, and without limitation, copper, aluminum, gold, etc. In some embodiments, the wire bonds 112 may be formed as or from ribbon cable as another bonding method. Such ribbon cable would be electrically similar to the illustrated wires but would be formed as a flat and wide electrical connection, rather than a circular wire form. It will be appreciated that other types of electrical connection (e.g., wires, ribbons, rods, etc.) may be used without departing from the scope of the present disclosure.

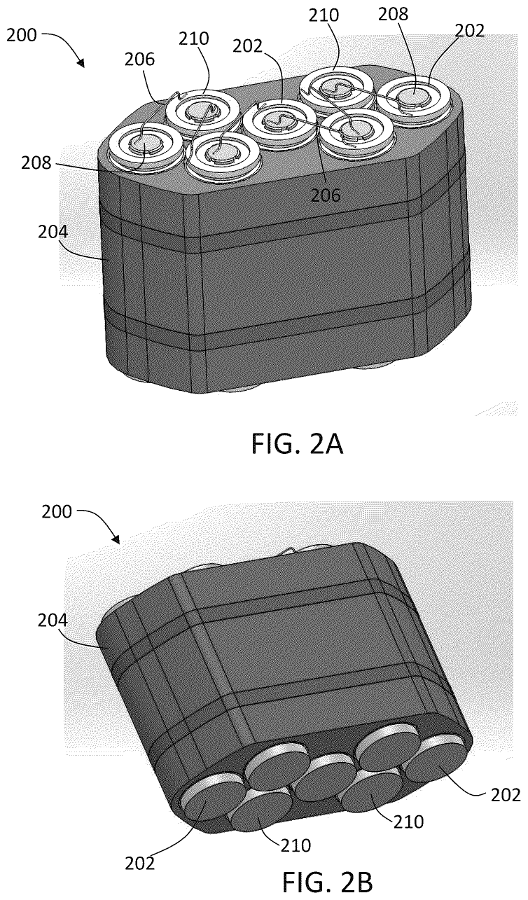

Each cell 102 includes a center “cap” of the individual cylindrical cells and is the positive terminal 110. The casing, enclosure, or outer layer of the individual cells 102 that contains the electrochemical components of the cells 102 (e.g., cathode(s), anode(s), separator(s), etc.) defines or forms the negative terminal of each individual cell 102. In some embodiments, such as shown and described with respect to FIGS. 2A-2B, because the negative terminal of each cell 102 is exposed at the top (e.g., surrounding the positive terminal 110) of each cell 102, this allows a wire bonding process to connect a battery in series (as compared to the parallel configuration shown in FIGS. 1A-1C) without having to touch the bottom of the cell pack, which can save time and cost. As with a wire bond on both the top and bottom of the cell, this process also allows for two wire bond fusing characteristics to be employed together for an even further refined fusing characteristic. For example, one wire bond could be responsible for short-circuit conditions, while the other could be responsible for unbalanced parallel strings coming into contact with one another.

Each wire bond 112 is configured based on, for example, the limitations of a respective cell 102 or what may promote a volatile event. The wire bond 112 can be systematically utilized to provide cell protection as a fusing element guarding against a cell 102 reaching these limitations. The wire bonds 112 may be configured with various characteristics or attributes to achieve the desired functionality. For example, the wire bonds 112 must be configured to carry current from the cells 102 into the conductor 106 during normal use and ensure that such wire bond 112 does not fail during such normal use. However, the wire bonds 112 are also configured to ensure severing the electrical connection between the cell 102 and the conductor 106 when certain conditions are met (e.g., short circuit, thermal runaway, volatile events, etc.). These characteristics of the wire bonds 112 can include, without limitation, wire length, wire diameter, wire geometry and/or geometric shape, material selection of the wire, material selection of an optional coating on the wire, inflection points along a wire length, etc.

As assembled, the cell assembly 100 is configured to supply electrical power from the cells 102 to an electrical load. As such, the cell assembly 100 includes a cell assembly positive terminal 114 (e.g., one or more terminals) for electrical connection. In some embodiments, and as shown in FIG. 1B, the cell assembly 100 includes an adhesive layer 116 configured to secure and attach the conductor 106 to the top of the cell assembly 100. Further, in this embodiment, the cell assembly 100 includes a non-conductive stiffener 118. The non-conductive stiffener 118 is configured to ensure that the conductor 106 is maintained as flat and stable relative to the housing 104 for optimal wire bond adhesion to the conductor 106. In some non-limiting examples, the adhesive layer 116 may be a double-sided pressure sensitive adhesive or epoxy and the non-conductive stiffener 118 may be a glass-reinforced epoxy laminate, a plastic sheet, injection molded part, or the like. These are merely examples of materials and structures that can be used to form these aspects in accordance with some non-limiting embodiments of the present disclosure.

FIG. 1C illustrates a bottom view of the cell assembly 100. In this configuration, negative terminals 120 of cells 102 are shown being electrically connected to a heatsink 122 of the cell assembly 100. That is, the negative terminals 120 of the cells 102 are electrically wire bonded by respective wire bonds 124 to recessed locations of the heatsink 122. The heatsink 122 is configured to operate similar to the conductor 106 of the positive side of the cell assembly 100. The heatsink 122 may be milled or by another method recessed, so the cell assembly 100 can sit flat on a surface without damaging or otherwise compromising the characteristics of the wire bonds 124. The heatsink 122 is configured to function as an electrical bus plate for the negative terminal(s) 111 of the cell assembly 100.

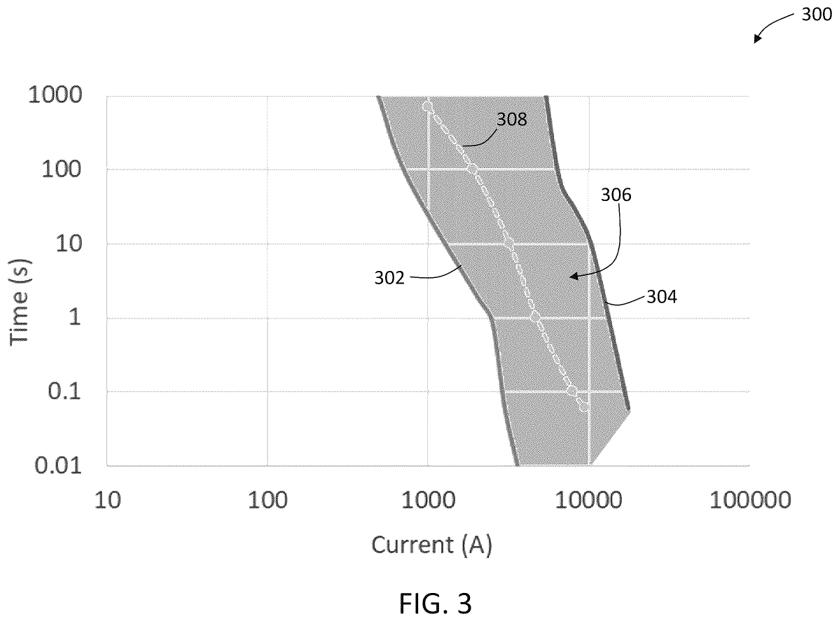

Wire attributes may be selected to configure a wire bond 112 as a fusing element for various current scenarios. For example, an appropriately designed wire bond 112 can act as a fusing element for both an upper limit current and a lower limit current scenario within the same application, as described with respect to FIG. 3. The wire bonds 112 provide the only electrical connection between each of the cells 102 and the conductor 106. Accordingly, when a wire bond 112 is broken (or opened) due to an excessive current passing therethrough (thus generating heat), a single cell 102 may be electrically isolated from the other cells 102 of the cell assembly 100. This may occur when one cell short circuits and the short-circuited cell draws current from all other connected cells through the conductor. This draw of current from the other cells can result in a high current passing through the wire bond and generate heat. As the current increases, so does the thermal energy within the wire bond. When the amount of current (or heat) exceeds a predetermined limit of the wire bond, the wire bond will break, melt, sever, or otherwise electrically disconnect the short-circuited cell from the conductor and thus sever the electrical connection to the other cells of the cell assembly. However, if the wire bonds are not sized appropriately, an initial rise in current from a shorted cell may be enough to not only open the wire bond of the shorted cell, but also to cause several or all of the wire bonds of adjacent cells to open, thus rendering the cell assembly inoperable. As such, this type of cascading of opening of wire bonds is to be avoided, and such avoidance may be achieved through defining the physical characteristics of the wire bonds.

Turning now to FIGS. 2A-2B, an alternative configuration of an electrochemical cell assembly 200 in accordance with an embodiment of the present disclosure is illustrated. The cell assembly 200 has a number of individual electrochemical cells 202, which are electrically connected in series to achieve a desired voltage. In an aspect, the electrochemical cells 202 are Lithium-ion cells, but may be any other suitable type of cell.

The cell assembly 200 includes a non-conductive housing 204 configured to retain and insulate the cells 202. In this embodiment, rather than connecting the individual cells 202 to a conductor (as shown in the embodiment of FIGS. 1A-1C), each cell 202 is electrically connected to an adjacent cell through a wire bond 206. Similar to the configuration of FIGS. 1A-1C, a center “cap” of the individual cylindrical cells 202 is a positive terminal 208. A negative terminal 210 surrounding each cell 202 is formed by a case or shell of the individual cells 202. As shown in FIG. 2A, the positive terminal 208 of a given cell 202 is electrically connected to the negative terminal 210 of an adjacent cell 202 by a wire bond 206. Because the negative terminal 210 is also exposed on the top (positive terminal 208) of each cell 202, this allows a wire bonding process to connect a battery in series without having to touch the bottom of the cell pack, which can save time and cost.

Turning now to FIG. 3, an Ft plot 300 is illustrated to provide an example of a down-select process of a wire bond in accordance with an embodiment of the present disclosure. As used herein, the term down-select refers to the process of determining wire bond parameters to narrow the possible range of the wire bond, as well as defining the upper and lower current limits of a given wire bond in order to achieve a desired result. Such down-select process involves adjusting variable characteristics of the wire bonds to meet application requirements. Such characteristics can include, without limitation, wire length, wire diameter, wire geometry and/or geometric shape, material selection of the wire, material selection of an optional coating on the wire, inflection points along a wire length, etc. The plot 300 is an Ft plot that represents an expression of the available thermal energy resulting from current flow. With regard to fuses, and as used herein, the term is expressed as melting, arcing, and total clearing Ft. The units for Ft are expressed in ampere-squared-seconds [A²-s].

In plot 300, a minimum time-current curve 302 (lower range of wire bond parameters) represents a minimum acceptable wire bond time-current curve, meaning a desired fusing characteristic would be greater in value (along the x-axis) on the time-current plot 300 relative to the minimum time-current curve 302. The minimum time-current curve 302 may be established or determined based on a component data sheet or stem from a project requirement, for example, and will define the minimum acceptable wire bond time-current curve in a given application. At currents and durations below the minimum time-current curve 302, a cell may be protected through non-fusing mechanisms, such as an electronic circuit breaker or software solution. Such control can be provided to ensure that the wire bonds do not fuse or sever at current levels that are not a risk to proper operation. As such, other mechanisms may be incorporated into the cell assemblies to ensure that desired power is supplied from the cell assemblies and to prevent premature fusing of wire bonds.

A maximum time-current curve 304 (upper range of wire bond parameters) represents a maximum acceptable wire bond time-current curve, meaning the ideal fusing characteristic would be lesser in value (along the x-axis) on the time-current plot 300 relative to the maximum time-current curve 304. The maximum time-current curve 304, when dealing with cell chemistry or battery packs, may be established, or obtained from an electrochemical cell data sheet or stem from cell thermal runaway testing, for example. Thermal runaway can occur when a cell discharges current at a rate higher than normal operation for an extended period of time. Such thermal runaway may be caused by a soft short, for example.

A wire bond region 306 is defined between the minimum time-current curve 302 and the maximum time-current curve 304. The wire bond region 306 defines the limits or bounds of the operational parameters that are acceptable for a given application or implementation for wire bonds in a cell assembly. By defining the wire bond region 306, a wire bond can be found to have properties and characteristics to fit within the wire bond region 306, and thus ensure a desired operation. In plot 300, curve 308 represents an example wire bond that is designed to fit within the wire bond region 306.

It is noted that both the x-axis and y-axis of plot 300 are logarithmic and represent current levels and time durations thereof. Upper and lower current limit scenarios are along the horizontal x-axis of FIG. 3, whereas the vertical range (y-axis) indicates the range of time from 10's of milliseconds to hundreds of seconds. Together, the current and time, for any given project parameters, produce curves that can be utilized to approximate bounds or limits (e.g., curves 302, 304) of the system or cell assembly. For example, referring to the maximum time-current curve 304, a wire bond will not fuse or open when a current of over 10,000 A is present for a period of time of below 0.1 s. However, such fusing will occur at a current level of 10,000 A when a duration of 10 s is present. Similarly, for currents of about 6,000 A, the wire bond will not fuse or open unless such current level is present for about 1,000 s. It will be appreciated that various plots may be generated for specific configurations and/or applications.

It will be appreciated by those of skill in the art that the time-current curves are approximations, and the lines are actually much wider at higher time intervals while being more precise at lower time intervals. For example, at more than is the thermal characteristics of the wire, coating, etc. have more time to affect the outcome of the fusing characteristics of the wire bond prior to severing. This results in a widening of the curves at the higher time intervals. For times shorter than 1 s, the thermal characteristics of the wire, coating, etc. do not have as much time to affect the outcome of the fusing characteristics of the wire bond, which results in a narrowing of the curve at lower time intervals.

The plot 300 allows for a lot of possible wire bond selections (e.g., with wire bond parameters within the wire bond region 306). However, not all system and cell parameters will allow for such possibilities (i.e., larger or smaller wire bond region). For example, some project parameters may specify a very narrow wire bond region 306 (i.e., extent along the x-axis) with the minimum and maximum time-current curves are close to each other along the x-axis, thus making the selection of the appropriate wire bond extremely important but can increase the difficulty of finding acceptable wire bond parameters, properties, and characteristics.

Once the minimum (minimum time-current curve 302) and maximum (maximum time-current curve 304) have been determined to an acceptable tolerance, a wire bond can be calculated to fall between the two (i.e., within the wire bond region 306). An ideal time-current curve represents a wire bond configured to achieve electrical communication during normal application and operation, with a desired margin of error, but is selected to open or break upon certain conditions, such as excessive current for a determined period of time, in order to minimize risk of damage to other cells, a cell assembly, or a connected electrical device/system. As such, the wire bond may be selected to remove a single cell that may be operating outside of expected or required operating parameters and prevent cascading of such adverse operating connections.

An ideal time-current curve calculation takes into consideration various wire attributes, including, but not limited to, diameter, length, density, material, coatings, etc. to produce a fusing characteristic within the chosen parameters. It will be appreciated by those of skill in the art that finding a wire bond that will meet all of the necessary parameters for a given application may require many or all of the wire attributes to be altered/selected in differing combinations to achieve a desired result (e.g., function to required parameters of the application). Examples of some differing fusing scenarios in accordance with embodiments of the present disclosure will now be described, with continued reference to FIGS. 1A-1C, 2A-2B.

In some embodiments, in a high current scenario, a given cell 102/202 may be subject to high current due to a short-circuit of a neighboring cell 102/202 within the cell assembly 100/200. To accommodate such high current events, attributes of the wire bonds 112/206 may be selected to protect against such a scenario. For example, each wire bond 112/206 may be designed to handle a short duration surge of current experienced by a shorted neighboring cell, while opening the wire bond of an associated shorted cell, allowing for continued use of the non-shorted cells. As such, the electrochemical cell assembly 100/200 will remain functional with the loss of a single cell. This may be achieved, for example, through the implementation of a parallel configuration of the cells 102/202 and a sufficient number of cells 102/202 to ensure continued operational capacity. For example, in accordance with some embodiments of the present disclosure, the cell assemblies 100/200 may be configured with more cells 102/202 than minimally necessary to achieve a predetermined operational capacity. In such configurations, during normal operation, each cell 102/202 may operate at a less than full capacity, but if one or more cells 102/202 fails (e.g., due to excessive current and an opening of the wire bonds 112/206), the remaining cells 102/202 may provide sufficient power to ensure continued operation of an associated system.

In some embodiments, in a moderately high current scenario, a higher current discharge (as compared to normal discharge) may be maintained for an extended period of time, which could cause thermal runaway. Such thermal runaway may negatively impact the cell assemblies 100/200. Accordingly, each wire bond 112/206 may be designed to open if a current discharge above a selected threshold is maintained for a selected period of time. That is, the materials, length, diameter, coatings, etc., may be selected for the wire bonds 112/206 to ensure that such wire bonds 112/206 will open upon a persistent high current for a predetermined period of time. It will be appreciated that the selection and configuration of the attributes of the wire bonds 112/206 are selected to prevent or avoid such opening of the wire bonds 112/206 if the current level is not at or above the threshold and/or the duration is not at or above the predetermined time period, thus ensuring the cell assembly 100/200 maintains operation with all cells 102/202 and does not unnecessarily open one or more wire bonds 112/206 of the cell assembly 100/200.

In accordance with some embodiments, protection may be designed into the wire bond 112/206 to address a surge current associated with closing unbalanced strings into each other. Depending upon the desired outcome, the wire bond 112/206 may be designed to either handle a surge and continue operation or open should the surge be undesirable. In addition, appropriately designing when the wire bond 112/206 opens could be used as a redundancy to software precautions. Such software may be stored in a controller or processor associated with a cell assembly and may be external to the individual cells. The software may be used as a first line of defense, wherein the software may be configured to open contactors to selectively disconnect one or more cells and/or control a warning LED or the like to provide a visual indicator of an error or issue associated with the cell assembly, etc. Should the condition continue to worsen, the wire bond would be the second line of defense, opening to prevent a catastrophic event, as described herein.

A wire bond 112/206 in accordance with the present disclosure may be designed by selecting values of wire attributes so that the wire bond 112/206 opens under predetermined conditions. In an aspect, the wire bond 112/206 may be designed to have a set resistance. It will be appreciated that the set resistance is a characteristic that determines the current level under which the wire bond 112/206 will open. Attributes of the wire bonds 112/206 that assist in obtaining a desired resistance include, without limitation, a material making up a wire used for the wire bond (e.g., copper, aluminum, etc.), a diameter of the wire, and a length of the wire. Other factors that can affect resistance and/or operation of the wire bond 112/206 include, without limitation, a temperature of operation and/or a loop or other geometric shape of the wire bond between a positive terminal and a negative terminal/conductor. In some embodiments, an inflection point may be incorporated into the wire bond which can result in a sharp point or abrupt change in the wire to thus focus the fusing/melting at such an inflection point.

In accordance with some embodiments of the present disclosure, the wire bond 112/206 may include a coating applied to the wire. For example, the wire bond can be coated with a suitable insulating material. Use of such a coating can extend the time to fuse on a time-current curve from an otherwise equivalent but uncoated wire. Thus, adding a polyimide or similar coating to a wire, such as a magnet wire, can provide more of a “slow blow” fusing characteristic (relatively long period of time for severing to occur) as opposed to the “fast blow” action of an uncoated wire (relatively short period of time for severing to occur).

In accordance with some embodiments of the present disclosure, a method of manufacturing and/or designing a wire bond, such as the wire bond 112/206, are provided herein. The method includes acquiring or determining a time-current curve for a given cell type and/or application (e.g., electric vehicle power supply) as explained above with respect to FIG. 3. Wire attributes such as the type of wire, material, diameter, length, and coating characteristics, etc. are selected to narrow or define the resistance of the wire to within a desired time-current curve. For example, with respect to diameter, if the diameter of the wire bond is increased, the wire bond will stay intact longer than a wire of the same length but smaller diameter. With respect to length, a longer wire bond will allow the wire bond to open sooner than the same diameter but shorter wire. In terms of materials, aluminum, copper, gold, and other electrically conductive materials have various densities and electrical properties and melting points that can be utilized to meet various wire bond parameters. The use of inflection points can be employed to pinpoint a location of the open circuit and cause the wire bond to open sooner than a wire of the same characteristics without an inflection point. Furthermore, the use of coatings can be employed to extend a time period a wire bond will open, creating more of a slow blow scenario. Various coatings, such as, polyimides, magnet wire, or vapor deposition can be used to vary the length of time needed. These and other properties and/or characteristics of the wire bonds may be configured to achieve a desired in-use operation and ensure opening of the circuit when required to prevent negative impacts on a cell assembly, as described herein.

Once the wire attributes are selected, the wires are formed based on the selected attributes. Each wire is then attached or bonded to a conductor or cell terminal. Then, depending upon whether the battery pack or cell assembly is a series or parallel configuration, a wire may be used to connect to a cell terminal (FIGS. 1A-1C) or to a separate cell terminal (FIGS. 2A-2B). For example, a wire bonder may be used to attach the wire. Wire bonders are capable of producing a wire bond in multiple shapes and sizes to fit many applications. Bonding coated wire, such as magnet wire, may be accomplished using a cross-groove wire bonding tool in lieu of a typical V-groove tool.

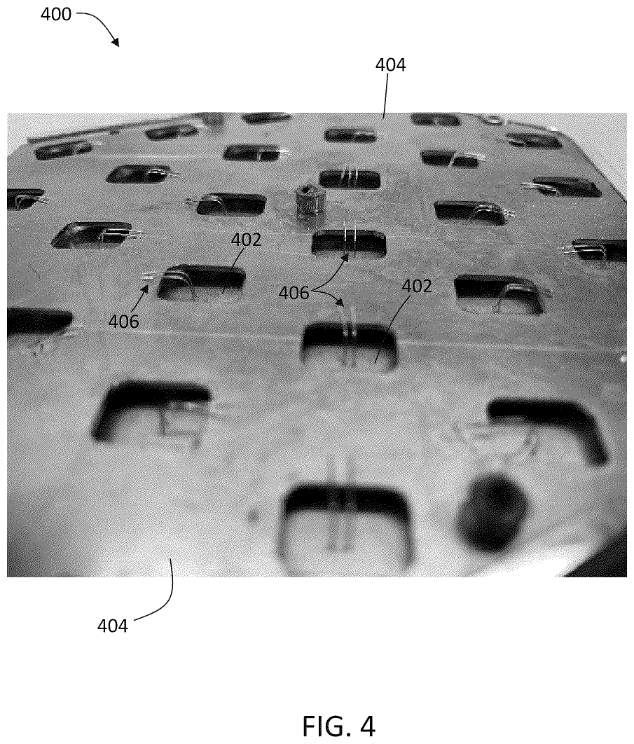

Although the above illustrated embodiments each employ a single wire bond connecting the individual cells to other cells (either directly or through a conductor), such single wire bond configurations are not to be limiting. For example, as noted above, multiple wire bonds may be used, without departing from the scope of the present disclosure. For example, referring now to FIG. 4, a cell assembly 400 having a plurality of cells 402 arranged therein is illustratively shown. The cell assembly 400 is similar to the configuration shown in FIGS. 1A-1C, having a parallel configuration with the cells 402 electrically connected to a conductor 404 through pairs of wire bonds 406 (as compared to single wire bonds). The wire bonds 406 may be similar to the single wire bond configurations, with such wire bonds 406 being designed in view of a wire bond region as shown in FIG. 3. Also shown in FIG. 4 is that the cells 402 may have a square shape, as compared to the cylindrical shape of the other embodiments illustrated herein. In such dual-wire configurations, it is advantageous to have each individual wire similar to the other wire of the pair such that the current would be shared evenly and thus opening/severing of the connection between a cell 402 and the conductor 404 occurs substantially simultaneously.

It is appreciated that the various components described herein may be made from any of a variety of materials including, for example, metal, copper, aluminum, stainless steel, nickel, titanium, plastic, plastic resin, nylon, composite material, glass, and/or ceramic, and combinations thereof for example, or any other material as may be desired. The compositions, methods, and articles described herein can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

“Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “some aspect”, “an aspect”, and so forth, means that a particular element described in connection with the aspect is included in at least one aspect described herein, and may or may not be present in other aspects. In addition, it is to be understood that the described elements may be combined in any suitable manner in the various aspects. A “combination thereof” is open and includes any combination comprising at least one of the listed components or properties optionally together with a like or equivalent component or property not listed

Unless defined otherwise, technical, and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular aspects have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A method for assembling a cell assembly, the method comprising:
installing a plurality of cells within a cell housing; and
electrically connecting each cell to each other cell through at least one wire bond, wherein each wire bond is selected to conduct current from a respective cell during normal operation and to sever such electrical connection through the wire bond when a predetermined current exceeds a threshold value for a predetermined period of time.

2. The method of claim 1, wherein the cells are electrically connected in series.

3. The method of claim 2, wherein a wire bond of one cell connects from a positive terminal of the cell to a negative terminal of an adjacent cell.

4. The method of claim 1, wherein the cells are electrically connected in parallel.

5. The method of claim 4, wherein each wire bond is connected to a conductor that electrically connects the plurality of cells.

6. The method of claim 1, further comprising selecting at least one of a wire length, a wire diameter, a wire coating, and a wire material of the wire bond such that the wire bond will sever based on the threshold value and predetermined period of time.

7. The method of claim 1, wherein the selection of the wire bond is determined to fall within a wire bond region of an Ft plot that is defined between a minimum time-current curve and a maximum time-current curve and wherein the severing of the wire bond occurs at one or more predetermined currents and durations of such predetermined currents.

8. A cell assembly comprising:
a plurality of cells arranged within a housing; and
at least one wire bond electrically connecting each cell of the plurality of cells to the other cells of the plurality of cells, wherein each wire bond is selected to conduct current from a respective cell during normal operation and to sever such electrical connection through the wire bond when a predetermined current exceeds a threshold value for a predetermined period of time.

9. The cell assembly of claim 8, wherein the cells are electrically connected in series.

10. The cell assembly of claim 9, wherein a wire bond of one cell connects from a positive terminal of the cell to a negative terminal of an adjacent cell.

11. The cell assembly of claim 8, wherein the cells are electrically connected in parallel.

12. The cell assembly of claim 11, further comprising a conductor, wherein each wire bond is connected to the conductor that electrically connects the plurality of cells.

13. The cell assembly of claim 12, further comprising an adhesive layer arranged between the conductor and the housing and configured to secure the conductor to the housing.

14. The cell assembly of claim 12, further comprising a stiffening layer arranged between the conductor and the housing and configured to provide stability to the conductor.

15. The cell assembly of claim 8, further comprising a cell assembly positive terminal and a cell assembly negative terminal configured to electrically connect to an external electrical device.

16. The cell assembly of claim 8, wherein the at least one wire bond of each cell is connected at a positive terminal of the respective cell, the cell assembly further comprising at least one additional wire bond configured to attach to a negative terminal of the respective cells.
